(19) United States
(12) Patent Application Publication
(10) Pub. No.: US 2010/0185468 A1
(43) Pub. Date: Jul. 22, 2010

(54) SYSTEM AND METHOD FOR PROVIDING GUARANTEED INCOME

(76) Inventor: Claude A. Methot, Larchmont, NY (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/691,711

(22) Filed: Jan. 21, 2010

Related U.S. Application Data
(60) Provisional application No. 61/146,294, filed on Jan. 21, 2009.

(51) Int. Cl. G06Q 40/00

(52) U.S. Cl. 705/4

(57) ABSTRACT

The present invention is directed towards a computerized method comprising receiving one or more contributions for an annuity from a qualified plan. At a first time, the method computes a first benefit base of the annuity based at least in part on the one or more contributions and determines a first guaranteed withdrawal amount as a function of the computed first benefit base. At a second time, the method computes a second income base based at least in part the one or more contributions and any amounts withdrawn from the annuity and determines a second guaranteed withdrawal amount as a function of the computed second benefit base.

### CLAIM OF PRIORITY

The present application claims priority to U.S. Provisional Application No. 61/146,294, entitled “SYSTEM AND METHOD FOR PROVIDING GUARANTEED INCOME,” filed on Jan. 21, 2009, the disclosure of which is hereby incorporated by reference herein in its entirety.

### CROSS REFERENCE TO RELATED APPLICATIONS

This application is related to the following commonly owned applications, each of which is hereby incorporated herein by reference in its entirety:
U.S. patent application Ser. No. 12/507,688, entitled “COMPUTERIZED METHOD AND SYSTEM FOR MANAGING A FINANCIAL PORTFOLIO RELATIVE TO MARKET VOLATILITY”, filed on Jul. 22, 2009;
U.S. patent application Ser. No. 12/433,416, entitled “SYSTEM AND METHOD FOR BENEFIT CONVERSION”, filed on Apr. 30, 2009;
U.S. patent application Ser. No. 12/463,147, entitled “SYSTEM AND METHOD FOR INSURANCE PRODUCT DEVELOPMENT”, filed on May 8, 2009;
U.S. Provisional Application No. 61/088,144, entitled “SYSTEM AND METHOD FOR INSURANCE PRODUCT DEVELOPMENT”, filed on Aug. 12, 2008; and
U.S. Provisional Application No. 61/050,014, entitled “SYSTEM AND METHOD FOR BENEFIT CONVERSION”, filed on May 2, 2008.

### COPYRIGHT NOTICE

A portion of the disclosure of this patent document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to providing an annuity contract to participants in defined benefit plans. More specifically, embodiments of the invention are directed towards systems, methods and computer program products for providing annuity contracts with guaranteed withdrawal amounts to participants.

### BACKGROUND OF THE INVENTION

The present invention generally relates to annuities and financial products for providing a guaranteed benefit. In an exemplary embodiment, an annuity is funded with contributions from a qualified plan (e.g., a defined contribution plan) and the guaranteed benefit is determined based, at least in part, on the contributions. The description below of the exemplary embodiments of the invention relate to the Crossings Variable Annuity available from the assignee of the present application.

Many employers provide qualified defined contribution plans (e.g., 401(k) plans) that allow employees to invest portions of their salaries for retirement on a tax-deferred basis. Employers encourage and facilitate these investments by providing automatic enrollment, contribution escalators, matching contributions, immediate vesting, etc. and the plans typically include a myriad of investment options (e.g., asset allocation portfolios, target-date funds, time horizon funds, etc.). Information about each investment option is provided to facilitate and guide investment, and the investment options typically cater to various investment objectives and risk-profiles. However, upon retirement, a former employee has little guidance about post-retirement investment for his/her accumulated savings, which can be daunting given lifestyle needs, healthcare costs, inflation and market volatility. Therefore, there exists a need for a financial product and system which facilitates post-retirement investment and ensures long-term financial security.

### SUMMARY OF THE INVENTION

The present invention is directed a computerized method comprising receiving one or more contributions for an annuity from a qualified plan. At a first time, the method computes a first benefit base of the annuity based at least in part on the one or more contributions and determines a first guaranteed withdrawal amount as a function of the computed first benefit base. In one embodiment, the first guaranteed withdrawal amount is a percentage of the computed first benefit base. At a second time, the method computes a second income base based at least in part the one or more contributions and any amounts withdrawn from the annuity and determines a second guaranteed withdrawal amount as a function of the computed second benefit base. In one embodiment, the method further comprises investing at least a portion of the one or more contributions in one or more investment portfolios. In an alternative embodiment, the method may further comprise offering the first guaranteed withdrawal amount when an investor reaches a predetermined age

### BRIEF DESCRIPTION OF THE DRAWINGS

The invention is illustrated in the figures of the accompanying drawings which are meant to be exemplary and not limiting, in which like references are intended to refer to like or corresponding parts throughout, and in which:

FIG. 1 is a block diagram illustrating a system for generating an annuity contract based on participant contributions according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

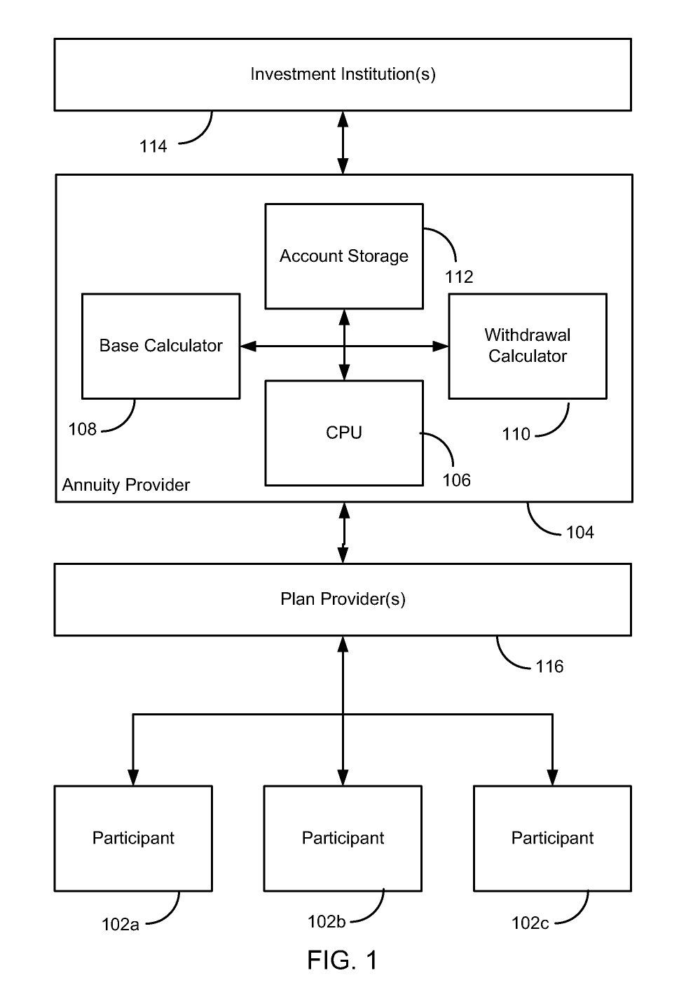

FIG. 1 presents a block diagram illustrating a system for generating an annuity contract based on participant contributions. According to the embodiment that FIG. 1 illustrates, a plurality of participants 102a, 102b, 102c may be communicatively coupled to an annuity provider 104 through a plurality of plan providers 116. In the illustrated embodiment, participants 102a, 102b, 102c may be connected to plan providers 116 via telephone, wide-area network or any other communications channels recognized in the art.

In the illustrated embodiment, participant 102a, 102b, 102c may purchase an annuity contract (e.g., Rollover IRA, Roth IRA, etc.) with contributions made to a qualified plan (e.g., a defined contribution plan), and the annuity contract may provide a guaranteed benefit that is determined based on the contributions. In the illustrated embodiment, a participant 102a, 102b, 102c may make qualified contributions to qualified plans offered by plan providers 116. In one embodiment, plan providers 116 may provide a plurality of pre-existing plans. For example, plan providers 116 may provide standard 401(k) plans as known in the art and may provide an option to participants to enroll with an annuity provider 104. In alternative embodiments, plan providers 116 may offer a plurality of plans for specific use with annuity provider 104.

A participant 102a, 102b, 102c (and any successor owner designated) may be required to be between 45 and 85 years old at issuance of the annuity contract. The successor owner may be named at issuance and may be the participant's spouse. If the marriage between the participant and successor owner is terminated, and payments under the guaranteed benefits have not yet commenced, the successor owner may be dropped from the annuity contract, or the successor owner can be replaced with a new spouse. Other limitations may be imposed on designation of the successor owner including, but not limited to, a time at which the successor owner or a new successor owner may be designated, a relationship of the successor owner to the participant, rights of the successor owner to the annuity contract upon death of the participant, etc. In one embodiment, a participant 102a, 102b, 102c may annuitize the annuity contract.

Plan providers 116 may be operative to transmit data to annuity provider 104 including, but not limited to, contributions to an annuity plan and requests for withdrawals. In one embodiment, contributions may comprise both initial contributions as well as supplementary contributions. An initial contribution to the annuity contract may be required to be greater than a predetermined minimum (e.g., $25,000). The initial contribution to the annuity contract may be made by, for example, a direct rollover from a qualified plan, a 403(b) plan, a governmental employer 457(b) plan, a designated Roth account under a 401(k) plan, and/or a Roth IRA, a rollover from an individual retirement arrangement, and/or a direct custodian-to-custodian transfer. Those of skill in the art will understand that additional sources may be utilized for the initial contribution to the annuity contract.

Central processing unit (“CPU”) 106 may be operative to receive the contribution data and the withdrawal requests and transmit the data or requests to base calculator 106, withdrawal calculator 110 or account storage 112 as will be discussed further herein. In the illustrated embodiment, CPU 106 may receive an initial contribution from plan providers 116. CPU 106 may transfer the initial contribution data to base calculator 108 wherein an income base is generated based on the initial contribution. In one embodiment, at issuance, an initial contribution may be the income base of an annuity contract. The income base may increase with the additional contributions according to a predetermined rate (e.g., dollar-for-dollar, pro rata, etc.), based on accumulated value (e.g., due to market performance of the selected investment options) or through bonuses (e.g., a withdrawal deferral bonus). The income base may not be reduced when a participant 102a, 102b, 102c makes withdrawals, unless, the withdrawals meet one or more predefined conditions. The income base may be fixed at a predetermined time (e.g., at issuance, annual anniversary of contract issuance date, etc.) or upon occurrence of a predetermined event (e.g., a participant 102a, 102b, 102c reaches a predetermined age).

CPU 106 may further be operative to receive supplemental contributions from plan providers 116. In the illustrated embodiment, a limit may be placed on additional contributions to the annuity contract. The limit on the additional contributions may be based on, for example, a type of the annuity contract, a source of the additional contribution, the participant's age at time of the additional contribution, an amount of the additional contribution, an aggregate amount of contributions made to the annuity contract, an aggregate amount of contributions made to all annuity contracts, etc.

CPU 106 is further coupled to withdrawal calculator 110. In the illustrated embodiment, withdrawal calculator 110 may be operative to calculate guaranteed withdrawal amount (“GWA”) based in part on a base calculated by base calculator 108. In an exemplary embodiment of the present invention, a guaranteed withdrawal benefit may begin at a predetermined age (or upon occurrence of a predetermined event) and allow a participant 102a, 102b, 102c to withdraw a predetermined amount from the annuity contract in predetermined intervals. For example, beginning at age 59½, a participant 102a, 102b, 102c may withdraw up to the GWA each year (or other defined time period) for the participant's life. If the participant 102a, 102b, 102c designates a successor owner (e.g., purchased a joint life annuity contract), the GWA may be provided for the lives of the participant 102a, 102b, 102c and the successor owner.

In an exemplary embodiment, the guaranteed withdrawal benefit allows a participant 102a, 102b, 102c to withdraw up to the GWA, which is a percentage of the income base. In other exemplary embodiments, a participant 102a, 102b, 102c may be allowed to withdraw up to a predetermined sum from the annuity contract. The guaranteed withdrawal benefit may not be cumulative. For example, if a participant 102a, 102b, 102c withdraws less than the GWA, the difference between the amount withdrawn and the GWA may not be added to a subsequent withdrawal period. In other embodiments, withdrawals of less than the GWA may be cumulative such that, for example, the portion of the GWA not withdrawn may be available for withdrawal in a subsequent withdrawal period.

As noted above, the income base can be reduced if a participant 102a, 102b, 102c makes a withdrawal meeting one or more predefined conditions. For example, if a participant 102a, 102b, 102c makes a withdrawal before he reaches a predetermined age or if a participant 102a, 102b, 102c withdraws more than the GWA in a given withdrawal period, base calculator 108 may recalculate the income base, and withdrawal calculator may recalculate the GWA. If the withdrawal meets any (or both) of the predefined conditions, the income base may be reset to a lesser of (i) the income base prior to the withdrawal and (ii) an account value following the withdrawal, and the GWA may also be recalculated to the lesser of (i) a predetermined percentage of the reset income base and (ii) the GWA prior to the withdrawal. If the account value falls to zero and a participant 102a, 102b, 102c has not made a withdrawal that meets the predefined conditions, the GWA may continue to be available to a participant 102a, 102b, 102c for the participant's life.

At a predetermined time (e.g., contract anniversary date, end of calendar year, participant's birthday, etc.) or upon occurrence of a predetermined event (e.g., a participant 102a, 102b, 102c reaching a predetermined age, account value reaching a predetermined value, etc.), the income base may be recalculated to the greater of (i) the account value and (ii) the most recent income base. The GWA may also be recalculated when the income base is recalculated.

In an exemplary embodiment, the annuity contract may provide an incentive for a participant 102a, 102b, 102c to forgo withdrawals. For example, a withdrawal deferral bonus may be provided which increases the income base by a predetermined percentage if a participant 102a, 102b, 102c forgoes the withdrawal (or a predetermined number of consecutive withdrawals). In another exemplary embodiment, the withdrawal deferral bonus may terminate when a participant 102a, 102b, 102c makes his2 first withdrawal or makes a withdrawal equal to the GWA.

Withdrawals may be taken through automatic or customized withdrawal plans (e.g., with variations on withdrawal frequency, amount withdrawn, withdrawal destination, etc.), which may also include a required minimum distribution service to meet lifetime required minimum distributions under federal income tax rules. The withdrawals may be taken on a pro rata basis from the investment options, from selected investment options, from the investment options in a round-robin fashion, etc.

In an exemplary embodiment, a charge may be deducted from the net assets of each investment option at predetermined intervals (e.g., daily). The charge may include, for example, mortality and expense risks charge, a charge for providing the guaranteed withdrawal benefit, etc. A charge may also be deducted from the account value when, for example, a withdrawal is made (e.g., a withdrawal charge), when annuity payments are scheduled to begin (e.g., charges designed to approximate certain taxes, such as premium state taxes), etc. Charges may also be deducted for management of the portfolios underlying the investment options. As understood by those of skill in the art, various tax rules and regulations may apply to the annuity contract and the features thereof

Annuity provider 104 may be operative to store data generated by base calculator 108 and withdrawal calculator 110 in account storage 112. Additionally, annuity provider 104 may be operative to store various metrics related to a participant account within account storage 112 including, but not limited to, participant ID, participant address, etc. During the course of calculations, CPU 106 may be operative to access account storage 112 and transmit data from account storage 112 to both base calculator 108 and withdrawal calculator 110. That is, CPU 106 may be capable of accessing historical account data from account storage for recalculating a participant's base and GWA, as previously described.

Annuity provider 104 may further be coupled to a plurality of investment institutions 114. The annuity provider 104 may provide several investment options for a participant 102a, 102b, 102c to invest the contributions, and a participant 102a, 102b, 102c may invest any portion of the contributions in any one or more of the investment options present in the investment institutions 114. In one exemplary embodiment, at least one of the investment options is a variable investment such that investment results depend on performance of an underlying portfolio, e.g., in periods of poor market performance, net return may result in a negative yield. The underlying portfolio may be selected from several portfolios which include various asset classes and categories and fulfill various objectives, e.g., high level of current income, current income and growth of capital (with emphasis on current income or growth of capital), long-term capital appreciation and current income, and long-term capital appreciation.

An account value may refer to a value of the investments in a given portfolio. That is, in an embodiment in which the investment options are variable, the account value may not be equal to the contributions, because the account value may change due to performance of the underlying portfolios. The account value (and the contributions) can be transferred among the investment options.

FIG. 1 is a conceptual illustration allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figure and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

We claim:

1. A computerized method, comprising:
receiving one or more contributions for an annuity from a qualified plan;
at a first time, computing a first benefit base of the annuity based at least in part on the one or more contributions;
determining a first guaranteed withdrawal amount as a function of the computed first benefit base;
at a second time, computing a second income base based at least in part the one or more contributions and any amounts withdrawn from the annuity; and
determining a second guaranteed withdrawal amount as a function of the computed second benefit base.

2. The method of claim 1 further comprising investing at least a portion of the one or more contributions in one or more investment portfolios.

3. The method of claim 2 wherein computing a second benefit base comprises computing the second benefit base further based on an accumulated value of the one or more investment portfolios.

4. The method of claim 1 further comprising offering the first guaranteed withdrawal amount when an investor reaches a predetermined age.

5. The method of claim 1 wherein the first guaranteed withdrawal amount is a percentage of the computed first benefit base.

6. The method of claim 1 wherein receiving one or more contributions comprises receiving contributions as a direct rollover from the qualified plan.

7. The method of claim 6 wherein the qualified plan comprises a 401(k) plan.

8. The method of claim 6 wherein the qualified plan comprises an IRA.

9. The method of claim 6 wherein the qualified plan comprises an employer retirement plan.

10. A computerized system for providing an annuity based on a qualified plan, comprising:
means for receiving one or more contributions for an annuity from a qualified plan;
means for computing, at a first time, a first benefit base of the annuity based at least in part on the one or more contributions;
means for determining a first guaranteed withdrawal amount as a function of the computed first benefit base;
means for computing, at a second time, a second income base based at least in part the one or more contributions and any amounts withdrawn from the annuity; and
means for determining a second guaranteed withdrawal amount as a function of the computed second benefit base.

11. A computer system for generating and managing an annuity based on participant contributions from qualified plans, the system comprising:
a processing unit operative to receive contribution data, the contribution data representing one or more contributions to an annuity on behalf of a participant from a qualified plan, and withdrawal request data representing requests for withdrawals;
a base calculator operative to receive the contribution data and withdrawal request data from the processing unit, calculate at a first time an initial income base based at least in part on the contribution data, and calculate at a second time a reset income base based at least in part on the contribution data and withdrawal request data;
a withdrawal calculator operative to receive the initial income base and reset income base calculated by the base calculator and calculate guaranteed withdrawal amounts based at least in part on the initial and reset income bases; and
an account storage computer medium coupled to the processing unit and operative to store account data regarding the participant and the data calculated by the base calculator and withdrawal calculator.

12. The computer system of claim 11, wherein the processing unit is operative to receive contribution data representing a plurality of contributions from the participant made at different times, the contributions including an initial contribution and one or more supplemental contributions.

13. The computer system of claim 12, wherein the base calculator is operative to calculate the initial income base based at least in part on the contribution data representing the initial contribution and to calculate the reset income base based at least in part on the contribution data representing the one or more supplemental contributions.

14. The computer system of claim 11, wherein the processing unit is coupled to a qualified plan provider via a communication network and is operative to receive the contribution data and withdrawal request data from the qualified plan provider.

15. The computer system of claim 11, wherein the base calculator is operative to calculate the reset income base based further on a performance of one or more investments into which the one or more contributions are invested.

16. The computer system of claim 11, wherein the base calculator is operative to calculate the reset income base by increasing the income base based on data representing deferred withdrawals.

17. The computer system of claim 11, wherein the base calculator is operative to calculate the reset income base by decreasing the income base when the withdrawal request data meets one or more predefined conditions selected from the group consisting of: a withdrawal by the participant prior to the participant reaching a predetermined age or a withdrawal by the participant of an amount greater than a guaranteed withdrawal amount for a given period of time as calculated by the withdrawal calculator.
